(19) United States
(12) Patent Application Publication
(10) Pub. No.: US 2024/0308564 A1
(43) Pub. Date: Sep. 19, 2024

(54) MULTI-WHEEL WHEEL BARROW DEVICE FOR MANEUVERING A STAIR ASSEMBLY

(71) Applicant: Diarmuid Griffin, Woodland Hills, CA (US)

(72) Inventor: Diarmuid Griffin, Woodland Hills, CA (US)

(21) Appl. No.: 17/967,288

(22) Filed: Oct. 17, 2022

(51) Int. Cl. B62B 5/02; B62B 1/18

(52) U.S. Cl. CPC B62B 5/028; B62B 1/18

(57) ABSTRACT

A wheel barrow device is disclosed. The wheel barrow device includes a receptacle configured to retain one or more materials. The wheel barrow device includes an elongated support comprising a base secured to a bottom exterior of the receptacle, and a set of fixed handles positioned on a first end of the elongated support. The wheel barrow device includes a rear barrow support positioned on a bottom portion of the support configured to contact a ground surface. The wheel barrow device includes a front tire assembly secured to a second end of the elongated support, wherein the front tire assembly comprises of a first wheel, a second wheel, and a third wheel. The wheel barrow device includes a wheel lock configured to retain one of the first wheel, the second wheel, or the third wheel for single wheel maneuvering.

### BACKGROUND

The present disclosure relates to wheeled apparatus for transporting loads. It is applicable to such apparatus which is designed to carry a load placed on it, for example, a dolly, cart, trolley, or wheelbarrow, as well as to apparatus where there is some form of container which is fitted with wheels to assist in transporting the container, for example, an article of luggage such as a suitcase or rucksack.

Such items are known in very many forms. In all of them, the motive power to move the load is supplied by the person using the apparatus, and the wheel or wheels is/are mounted so as to be freely rotatable about its/their axes (hereinafter called wheel axes for simplicity). In some such apparatus, for example, luggage trolleys, it is known to provide means to brace the apparatus against movement down a plurality of steps of a step assembly, typically through the use of user-supplied force and adjustment. Often times the user-supplied force and adaption can come with challenges when navigating a step assembly that may have turns, uneven steps, or a steep incline that may make it difficult to maneuver. As such, there is a long-felt need for a wheelbarrow design that can overcome these challenges and ease the ability to transport materials from one location to another across varied terrain, inclines, declines, and specifically stair assemblies.

### BRIEF SUMMARY

A wheel barrow device is disclosed. The wheel barrow device includes a receptacle configured to retain one or more materials. The wheel barrow device includes an elongated support beam comprising a base secured to the bottom exterior of the receptacle and a set of fixed handles positioned on the first end of the elongated support. The wheel barrow device includes rear barrow supports positioned on a bottom portion of the support configured to contact a ground surface. The wheel barrow device includes a front tire assembly secured to a second end of the elongated support, wherein the front tire assembly comprises a first wheel, a second wheel, and a third wheel. The wheel barrow device includes a wheel lock configured to retain one of the first wheel, the second wheel, or the third wheel for single wheel maneuvering.

This summary is provided merely for purposes of summarizing some example embodiments, so as to provide a basic understanding of some aspects of the subject matter described herein.

In one example, the set of fixed handles comprising a flat portion proportionate to the elongated portion, and a rounded portion opposite the flat portion.

In one example, the receptacle barrow is comprised of durable material including plastic, stainless steel, iron, a rubber-based material, or aluminum.

In one example, the receptacle barrow is comprised of durable material including plastic, stainless steel, iron, a rubber-based material, or aluminum.

In one example, the front tire assembly comprises a mount configured to retain the first wheel, the second wheel, and the third wheel at each of a first, second, and third intersection point of one or more sides of the mount.

In one example, the mount is a triangle.

In one example, the first, second, and third wheels are mounted on the mount via a plurality of rotating axles.

In one example, the mount is mounted to the second end of the elongated support via a rotating axle assembly.

In one example, the rotating axle assembly of the mount is configured to rotate the first second, and third wheel while being maneuvered in an upward or downward direction of a stair assembly.

In one aspect, the wheel barrow device includes a wheel assembly. The wheel assembly includes a triangle-shaped wheel mount mounted to a support structure, wherein the triangle-shaped wheel mount is configured to rotate about an axle assembly. The wheel assembly includes a plurality of wheels attached to each intersection of one or more sides of the wheel mount. The plurality of wheels comprises a first wheel, a second wheel, and a third wheel. The wheel assembly includes a plurality of rotating axles secured to each intersection point of the wheel mount. Each of the rotating axles is configured to retain each of the first, second, and third wheels.

In one aspect, a method of assembling a multi-wheel assembly is disclosed. The method includes attaching the first plate of a triangle-shaped mount to the first side of a support structure. The triangle-shaped mount is configured to rotate about an axle assembly. The method includes securing a plurality of wheels to a plurality of rotating axles. The rotating axles are positioned at each intersection of one or more sides of the wheel mount. The method includes fastening a second plate of the triangle-shaped mount to a second side of the support structure and an opposite end of each of the plurality of rotating axles.

This summary is provided merely for purpose of summarizing some example embodiments so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of the wheel barrow device, in accordance with one embodiment.

FIG. 2 illustrates a side view of the front wheel assembly of the wheel barrow device, in accordance with one embodiment.

FIG. 3 illustrates a perspective view of the front wheel assembly of the wheel barrow device in operation on a stair assembly, in accordance with one embodiment.

FIG. 4 illustrates an exploded view of a wheel barrow device, in accordance with one embodiment.

FIG. 5 illustrates a flow chart for assembling a multi-wheel wheel barrow device, in accordance with one embodiment.

FIG. 6 illustrates an embodiment of a wheel locking device of the multi-wheel wheel barrow device, in accordance with one embodiment.

FIG. 7 illustrates an embodiment of the wheel locking device of the multi-wheel wheel barrow device, in accordance with one embodiment.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “wheel” and “wheeled” used herein are intended to cover both standard wheels—usually discs with or without an outer peripheral cover or tire, and other rotatable members which function as wheels, for example hemispherical or spherical rollers.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The preferred embodiment herein described is not intended to be exhaustive or to limit the invention to the precise form disclosed. It is chosen and described to explain the principles of the invention and its application and practical use to enable others skilled in the art to follow its teachings.

The present disclosure provides for embodiments of a wheel barrow device that is configured for navigating rough terrain and/or multiple steps of a stair assembly. In some instances, a stair assembly comprises of a plurality of steps that may vary in distance, height, angle, incline, or position. The steps in some cases may have multiple landings, may have a winding pattern, a zig-zag pattern, or even be uneven.

The wheel barrow device described herein allows a user to navigate a stair assembly while carrying a load of materials. The materials therein may vary in weight, distribution of weight, length, height, and amount. Based on these factors, the wheel barrow may require the user to adjust how they carry the load of materials, and the angle of the wheel barrow receptacle in response to the load of materials' varying characteristics, especially when navigating an incline such as a stair assembly.

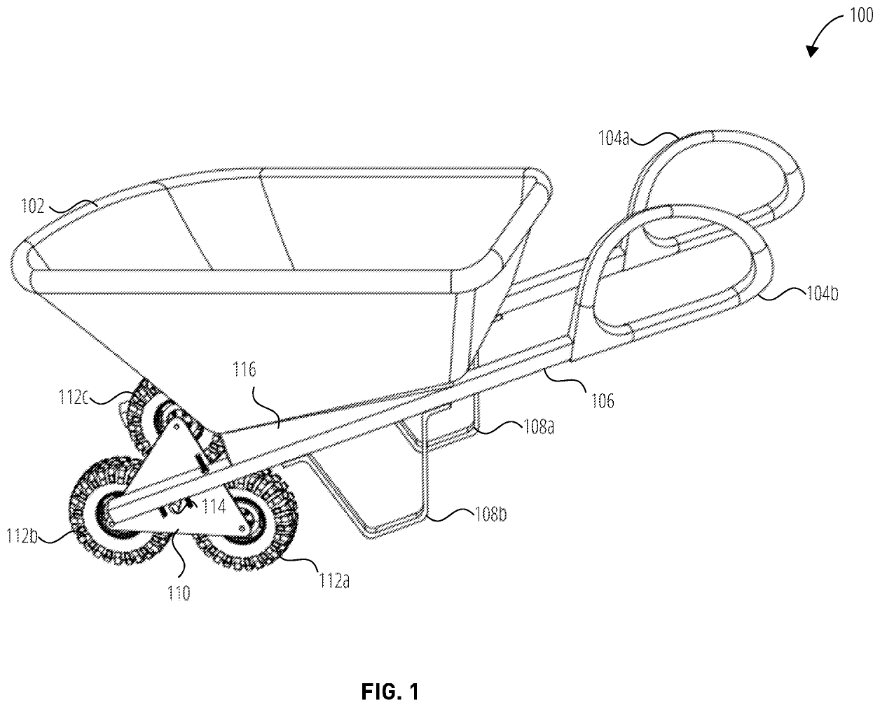

FIG. 1 illustrates an embodiment of the wheel barrow device 100, in accordance with one embodiment. The wheel barrow device 100 is constructed to navigate terrains that a single wheel wheel barrow would be unable to maintain stability within. Accordingly, the wheel barrow device 100 replaces a single wheel on a wheel barrow with three wheels 112a-c configured on a triangle front wheel assembly 110. The wheels 112a-c are configured with a central axle 114 so that the triangulated wheels 112a-c rotate individually and also can rotate on the central axle 114, therefore making negotiating steps possible. The central axle is secured through a retainer that is mounted on the elongated support 106.

The elongated support 106 is configured to evenly distribute a load of materials that is being retained by a receptacle 102. The receptacle is curved in nature in order to carry liquid, solid material, or other compounds while preventing the spillage of the materials from the receptacle 102. The receptacle 102 is supported by the elongated support 106 by a raised base 116. The receptacle 102 can be retained on the base 116 with a plurality of securing members that ensures the receptacle 102 is securely attached to the base 116. The elongated support further includes a plurality of rear barrow supports 108a-b. The rear barrow supports 108a-b are configured to contact a ground surface when a user decides to rest a load of materials in the receptacle 102 from a carrying position. The rear barrow supports 108a-b are secured to the elongated support 106 by an additional set of securing members that are configured to retain the rear barrow support 108a-b to the elongated support 106 in at least two locations. A bottom portion of the rear barrow support 108a-b includes a flat portion in order for the wheel barrow 100 to evenly set on a ground surface and adequately support the materials in the receptacle 102.

The elongated support 106 further comprises of the front wheel assembly on one end and a set of handles 104a-b on a second end. The handles 104a-b are configured to be secured to the second end of the elongated support 106, where a straight portion of the handles 104a-b takes on the shape of the elongated support 106. The additional portion of the handles 104a-b not contacting the elongated support 106 is configured to take on a curved shape. Because the tool is designed to navigate a hillside, mountainside or stair assembly, the handles 104a-b are mounted on with the rounded portion facing upwards in order to provide additional support for the user when attempting to support materials in the receptacle 102 while navigating an incline.

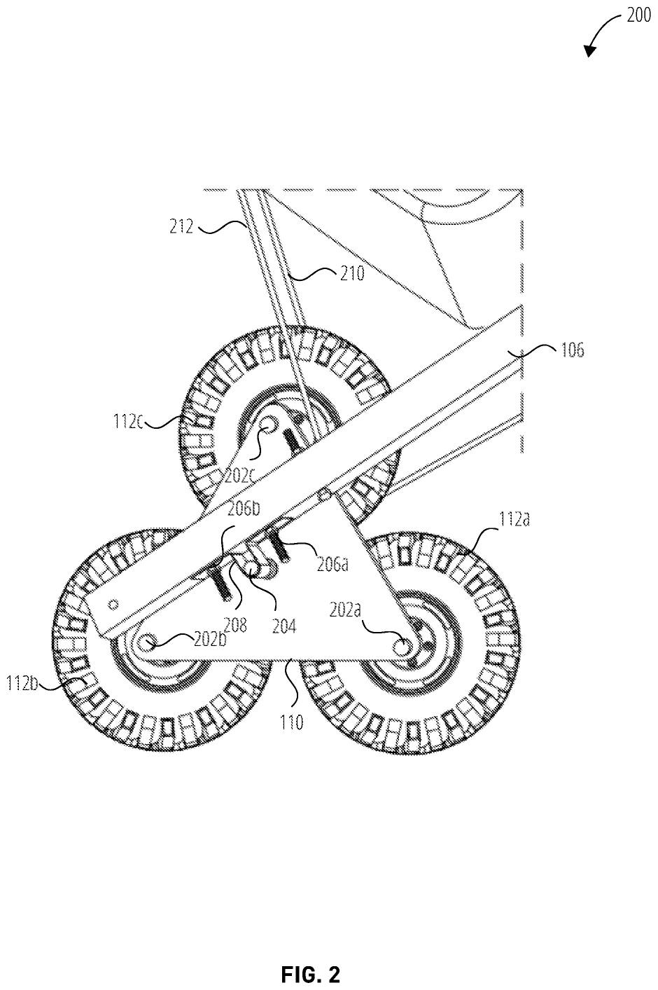

FIG. 2 illustrates a side view of the front wheel assembly 200 of the wheel barrow device in accordance with one embodiment. The front wheel assembly 200 is configured to operate as a triangle-shaped wheel mount 110. The triangle-shaped wheel mount 110 is configured to support a plurality of wheels 112a-c. The plurality of wheels 112a-c includes a first wheel 112a, a second wheel 112b, and a third wheel 112c. In some examples, additional wheels could be added to the front wheel assembly 200 in order to provide for additional variations of supporting the load while facing an incline of varying angles and terrain. Each of the plurality of wheels 112a-c are supported on the triangle shaped wheel mount 110 by a plurality of wheel axles 202a-c. The plurality of wheels 112a-c comprises of a first wheel axle 202a, a second wheel axle 202b, and a third wheel axle 202c. The triangle shaped wheel mount 110 is mounted to the elongated support 106 via an axle of the front tire assembly 204. The axle of the front tire assembly 204 is retained in an axle retainer 208, that is secured to the elongated support 106 via a first bolt and nut securing device 206a and a second bolt and nut securing device 206b. The plurality of wheels 112a-c are attached to each intersection of one or more sides of the wheel mount, wherein the plurality of wheels comprises a first wheel 112a, a second wheel 112b, and a third wheel 112c. Further the plurality of wheel axles 202a-c are secured to each intersection point of the triangle-shaped wheel mount 110. Each of the plurality of wheels 112a-c are configured to rotate about their retention locations and configured to retain each of the plurality of wheels 112a-c.

In some examples, the first wheel 112a, second wheel 112b, and third wheels 112c are configured to rotate about the rotating axles in a clockwise and counterclockwise direction.

In some examples, the front wheel assembly 200 can further include a pair of support plates configured to retain the first wheel 112a, second wheel 112b, and third wheels 112c on a first side and a second side.

In some examples, the receptacle 102 can be retained and secured to the elongated support 106 with a first barrel securing device 212 and a second barrel securing device 210.

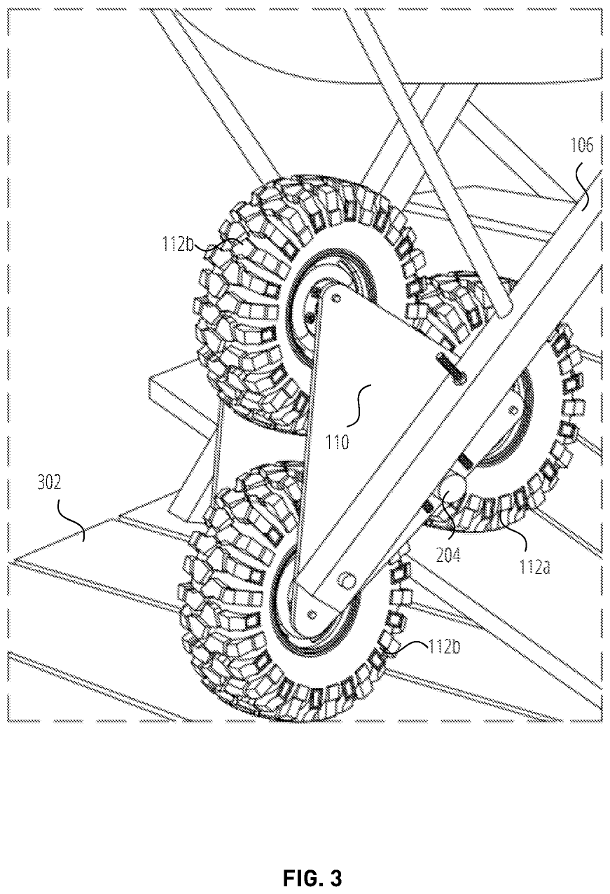

FIG. 3 illustrates a perspective view of the front wheel assembly of the wheel barrow device in operation on a stair assembly, in accordance with one embodiment. As shown in FIG. 3 the front wheel assembly 200 as shown in FIG. 2 is able to stabilize a wheel barrow device as it is descending or ascending a stair assembly 302 or another inclined location such as a hillside or mountainside, while retaining material within its receptacle 102. For example, as a user descends the wheel barrow down a stair assembly 302 the plurality of wheels 112a-c are configured to rotate in a counterclockwise motion, with each of the first wheel 112a, the second wheel 112b, and the third wheel 112c contacting each step, one after the other until a flat surface is reached. As the plurality of wheels 112a-c rotate end over end, sequentially, the wheels are able to ensure a smooth descent down the steps without jarring loose material from within the receptacle 102 (FIG. 1).

Alternatively, as the user decides ascend a stair assembly 302 or a hillside or mountainside, the plurality of wheels 112a-c are configured to rotate in a clockwise fashion, sequentially. As the user ascends the incline or the stair assembly 302, each of the first wheel 112a, the second wheel 112b, and the third wheel 112c are configured to touch the next step or next inclined location sequentially while maintaining the proper weight distribution and balance across the elongated support 106 to prevent the loss of material from the receptacle.

For example, the first and second support plates are configured to rotate about the axle assembly attached to the support structure in a clockwise and a counter-clockwise direction.

In some examples, the first and second support plates are configured to rotate the plurality of wheels about the axle assembly in a clockwise direction upon being maneuvered in a backward direction while being pulled up a stair assembly.

In some examples, the first and second support plates are configured to rotate the plurality of wheels about the axle assembly in a counterclockwise direction upon being maneuvered in a forward direction while being pushed down a stair assembly.

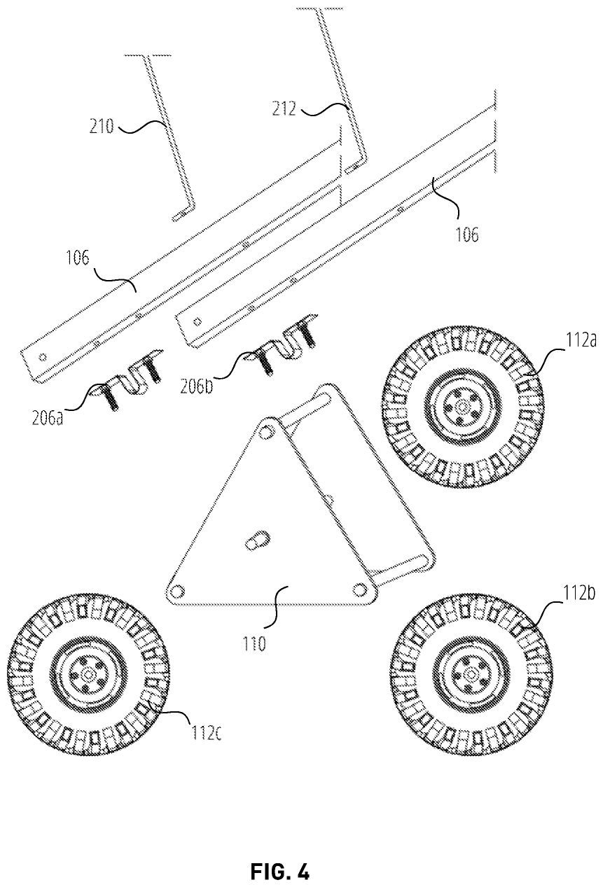

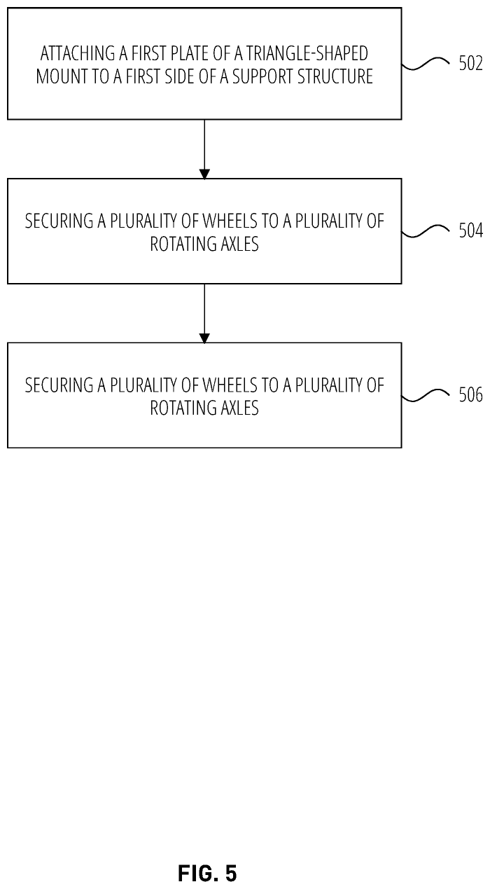

FIG. 4 illustrates an exploded view of a wheel barrow device 100, in accordance with one embodiment. As shown in FIG. 4, the wheel barrow device 100 can comprise of many components in order to function in accordance with an embodiment of the wheel barrow device 100 as shown in FIG. 1. The parts as shown can include, but are not limited to a first wheel 112a, a second wheel 112b, a third wheel 112c, a front tire assembly 110, a first securing device 206a, a second 206b, a plurality of elongated supports 106 and a plurality of barrel securing devices 210 and 212. The assembly of each of these components within an embodiment of the disclosure is provided below in a method illustrated by a flowchart of FIG. 5.

FIG. 5 illustrates a flow chart for assembling a multi-wheel wheel barrow device, in accordance with one embodiment. In some examples, the multi-wheel wheel barrow device can have multiple applications. Accordingly, various applications of the device can also be tied to multiple users who may have different methods of carrying loads of materials while also varying in strength capability and material weight.

According to some examples, the method includes attaching the first plate of a triangle-shaped mount to the first side of a support structure at block 502. In some examples, the triangle-shaped mount is configured to rotate about an axle assembly. Accordingly, the first plate and the second plate can be positioned parallel to each other. The first and second support plates can further be configured to rotate about the axle assembly attached to the support structure in a clockwise and plate counter-clockwise direction. In some examples, the first and second support plates are configured to rotate the plurality of wheels about the axle assembly in a clockwise direction upon being maneuvered in a backward direction while being pulled up a stair assembly.

Additionally, the first and second support plates are configured to rotate the plurality of wheels about the axle assembly in a counterclockwise direction upon being maneuvered in a forward direction while being pushed down a stair assembly. In some examples, the rotation of the first and second support plates is configured to rotate the plurality of wheels to reduce the bouncing of the support structure while being maneuvered about the stair assembly. In some examples, the axle assembly is mounted within a retaining location affixed to at least one portion of the support structure.

According to some examples, the method includes securing a plurality of wheels to a plurality of rotating axles, wherein the rotating axles are positioned at each intersection of one or more sides of the wheel mount at block 504.

Accordingly to some examples, fastening a second plate of the triangle-shaped mount to a second side of the support structure and an opposite end of each of the plurality of rotating axles at block 506.

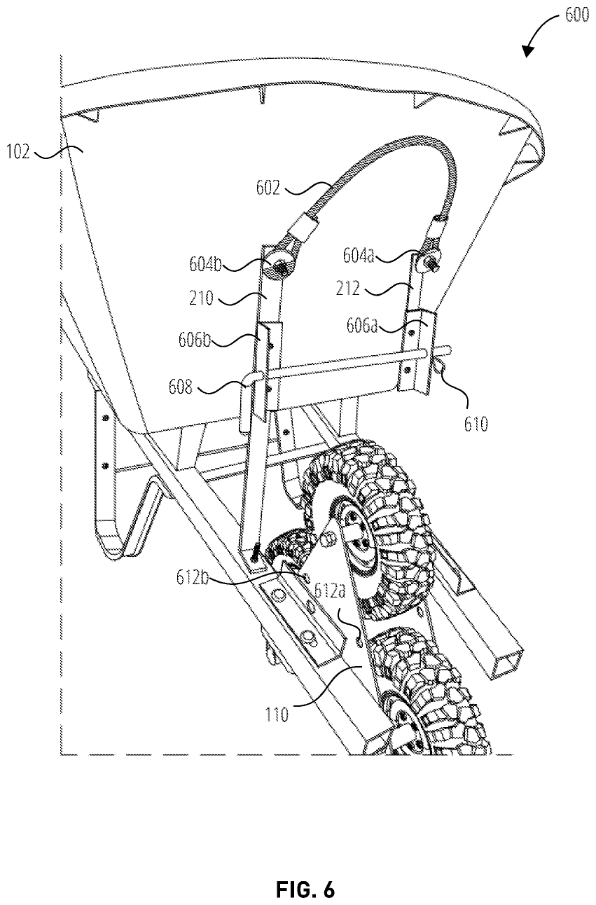

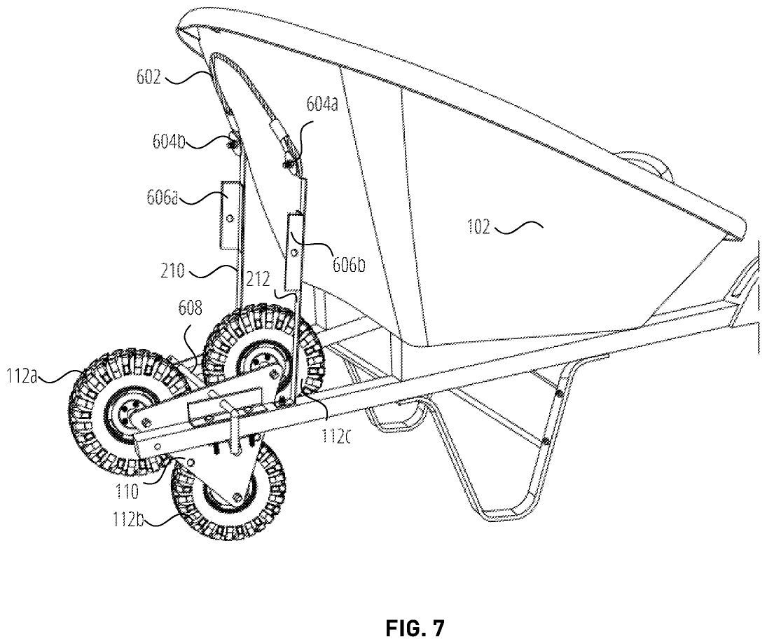

FIG. 6 illustrates an embodiment of a wheel locking device 600 of the multi-wheel wheel barrow device, in accordance with one embodiment. The wheel locking device 600 comprises of a receptacle support wire 602 configured to provide the receptacle 102 additional support when the weight of the materials within the receptacle 102 may lean more forward when the wheel barrow device 100 is maneuvered down an incline or stair assembly 302. For example, often times materials, especially if moveable like rocks, sediment, or sand, are likely to shift in a forward direction, which could provide stress on the front portion of the receptacle 102. In order to prevent early wear and tear and over stressing the receptacle 102, the receptacle support wire 602 can provide additional support that allows the receptacle 102 to maintain its strength and resiliency. The receptacle support wire 602 is secured to the receptacle 102 via a first receptacle support securing device 604a and a second receptacle support securing device 604b. Each of the first and second receptacle support securing devices 604a-604b are secured through the inside of the receptacle 102 via a bolt that is passed through a receiving location of the barrel securing device 210 and 212 and secured with a fastening nut. The wheel locking device 600 further includes a receptacle support 606a and 606b, which each includes receiving locations that are configured to retain a wheel lock 608. The wheel lock 608 is a bar that passes through each of the receiving locations when the front tire assembly 110 is in a multi-wheel mode or the user has decided to use the front tire assembly 110 to maneuver an incline or decline terrain. An example embodiment is depicted in FIG. 7.

FIG. 7 illustrates an embodiment of the wheel locking device of the multi-wheel wheel barrow device as described in FIG. 6, in accordance with one embodiment. As depicted, the wheel locking device 600 is configured to provide a user the ability to lock the front tire assembly 110 in place where only one wheel is configured to contact the ground, without the ability to rotate as discussed in the above embodiments. In some examples, a user of the wheel barrow device 100 may find it necessary to prevent the front tire assembly 110 from rotating as the stair assembly 302 or incline has already been navigated, and a setting for a flat terrain is needed. As such, the user may remove the wheel lock 608 from the receptacle supports 606a and 606b, and place the wheel lock 608 through an additional set of receptacle supports in a first locking device location 612a and a second locking device location 612b. The wheel lock is placed through a matching locking device location on the second plate of the front tire assembly 110, in order to create a barring, which prevents the front tire assembly 110 from rotating in either direction. The wheel lock 608 can be secured in place through either of the wheel locking device locations 612a and 612b or the receptacle support 606a and 606b with a wheel lock pin 610 that passes through an insert in the wheel lock.

In some examples, the front tire assembly 110 can be rotated in either direction in order to secure an intended wheel that is desired to be maneuvered. The wheel lock 608 is then placed in between either of the plurality of wheels 112a-c, and secured by the wheel lock pin 610. In some instances the front tire assembly 110 can include more than three wheels as depicted in FIG. 7. Accordingly, the wheel lock 608 could be placed in additional locking device locations that may cause more than one wheel to contact the ground in order to provide additional support.

In some examples. Each of the plurality of wheels 112a-c may vary in size, tread type, or terrain type in order to provide additional support for the materials that are being carried in the receptacle 102. A wheel can be chosen accordingly, that fits the terrain that will be maneuvered by the user, and the wheel lock 608 placed accordingly.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A wheel barrow device comprising:
a receptacle configured to retain one or more materials;
an elongated support comprising a base secured to a bottom exterior of the receptacle, and a set of fixed handles positioned on a first end of the elongated support;
a rear barrow support positioned on a bottom portion of the support configured to contact a ground surface;
a front tire assembly secured to a second end of the elongated support, wherein the front tire assembly comprises of a first wheel, a second wheel, and a third wheel; and
a wheel lock configured to retain one of the first wheel, the second wheel, or the third wheel for single wheel maneuvering.

2. The wheel barrow device of claim 1, wherein the receptacle is secured to the elongated support with one or more of a bolt and nut assembly, a plurality of weldings, a fixed fastener or a removable fastener.

3. The wheel barrow device of claim 1, wherein the set of fixed handles comprising a flat portion proportionate to the elongated portion, and a rounded portion opposite the flat portion.

4. The wheel barrow device of claim 1, wherein the receptacle barrow is comprised of durable material including plastic, stainless steel, iron, a rubber-based material, or aluminum.

5. The wheel barrow device of claim 1, wherein the rear barrow support is positioned between the handles and the front tire assembly to provide a leveled support to the materials in the receptacle.

6. The wheel barrow device of claim 1, wherein the front tire assembly comprises a mount configured to retain the first wheel, the second wheel, and the third wheel at each of a first, second, and third intersection point of one or more sides of the mount.

7. The wheel barrow device of claim 6, wherein the mount is a triangle.

8. The wheel barrow device of claim 6, wherein the first, second, and third wheels are mounted on the mount via a plurality of rotating axles.

9. The wheel barrow device of claim 6, wherein the mount is mounted to the second end of the elongated support via a rotating axle assembly.

10. The wheel barrow device of claim 9, wherein the rotating axle assembly of the mount is configured to rotate the first second, and third wheel while being maneuvered in an upward or downward direction of a stair assembly.

11. A wheel assembly comprising:
a triangle shaped wheel mount, mounted to a support structure, wherein the triangle shaped wheel mount is configured to rotate about an axle assembly;
a plurality of wheels attached to each intersection of one or more sides of the wheel mount, wherein the plurality of wheels comprises a first wheel, a second wheel, and a third wheel; and
a plurality of rotating axles secured to each intersection point of the wheel mount, wherein each of the rotating axles are configured to retain each of the first, second, and third wheel.

12. The wheel assembly of claim 11, wherein the first, second, and third wheels are configured to rotate about the rotating axles in a clockwise and counterclockwise direction.

13. The wheel assembly of claim 11, further comprising a pair of support plates configured to retain the first, second, and third wheels on a first side and a second side.

14. A method of assembling a multi-wheel assembly:
attaching a first plate of a triangle-shaped mount to a first side of a support structure, wherein the triangle-shaped mount is configured to rotate about an axle assembly;
securing a plurality of wheels to a plurality of rotating axles, wherein the rotating axles are positioned at each intersection of one or more sides of the wheel mount; and
fastening a second plate of the triangle-shaped mount to a second side of the support structure and an opposite end of each of the plurality of rotating axles.

15. The method of claim 14, wherein the plurality of wheels comprises a first wheel, a second wheel, and a third wheel.

16. The method of claim 14, wherein the first plate and the second plate are positioned parallel to each other.

17. The method of claim 14, wherein the first, second, and third wheels are configured to rotate about the rotating axles in a clockwise and counterclockwise direction.

18. The method of claim 16, wherein the first and second support plate are configured to rotate about the axle assembly attached to the support structure in a clock-wise and a counter clock wise direction.

19. The method of claim 18, wherein the first and second support plate are configured to rotate the plurality of wheels about the axle assembly in a clockwise direction upon being maneuvered in a backwards direction while being pulled up a stair assembly.

20. The method of claim 18, wherein the first and second support plate are configured to rotate the plurality of wheels about the axle assembly in a counterclockwise direction upon being maneuvered in a forward direction while being pushed down a stair assembly.
